(19) United States
(12) Patent Application Publication
(10) Pub. No.: US 2020/0001935 A1
(43) Pub. Date: Jan. 2, 2020

(54) ACTIVE BODY PANELS FOR REAR PILLARS OF A VEHICLE

(71) Applicant: GM Global Technology Operations LLC, Detroit, MI (US)

(72) Inventors: Eric S. Nielsen, Sterling Heights, MI (US); Magalie Debellis, Beverly Hills, MI (US); Darren T. Luke, West Bloomfield, MI (US); Nicholas J. Christoff, Macomb, MI (US); Steven A. Del Gaizo, Ferndale, MI (US); Suzanne Cody-Gump, Metamora, MI (US); John H. Bednarchik, Royal Oak, MI (US)

(21) Appl. No.: 16/024,041

(22) Filed: Jun. 29, 2018

(51) Int. Cl. B62D 35/00; B62D 25/04; B62D 25/08

(52) U.S. Cl. CPC B62D 35/007; B62D 25/08; B62D 25/04

(57) ABSTRACT

A vehicle having an active panel is disclosed. The vehicle defines a rearmost surface. The vehicle includes a frame defining a D-pillar, an active panel, and an actuation system. The active panel extends in a fore-and-aft direction of the vehicle and covers at least a portion of the D-pillar. The active panel defines a trailing edge that is oriented towards an aft direction and is moveable between a stowed position and a deployed position. The actuation system is operatively connected to the active panel and is configured to extend the active panel from the stowed position into the deployed position and from the deployed position into the stowed position. The trailing edge of the active panel is substantially aligned with the rearmost surface of the vehicle in the stowed position and extends beyond the rearmost surface of the vehicle in the deployed position.

### INTRODUCTION

The present disclosure relates to a vehicle having a D-pillar. In particular, the disclosure relates to an active panel that is extended into a deployed position to reduce aerodynamic drag.

The body structure of a smaller vehicle includes an A-pillar, B-pillar, and a C-pillar. In smaller vehicles such as coupes and sedans the C-pillar is the rearmost roof support structure located behind the rear doors of a vehicle, the B-pillar is the support structure between the front and rear doors of a vehicle, and the A-pillar is the support structure located on both sides of the front windshield. Larger vehicles having an extended cargo area such as sport utility vehicles, minivans, and wagons further include a D-pillar as well. In larger vehicles, the D-pillar is the rearmost roof support structure and the C-pillar is the support structure behind the rear doors.

Aerodynamics has long played a role when determining the style and shape of a vehicle body. For example, when a vehicle is being designed the associated drag coefficient C_{D} may be considered along with other performance characteristics. It is to be appreciated that the aerodynamic drag of a vehicle is proportional to the square of vehicle speed. For example, if the vehicle doubles speed the drag coefficient C_{D} quadruples in value. Therefore, the effects of aerodynamic drag become more significant when the vehicle operates at highway speeds. The increase in drag requires the engine of the vehicle to work harder, which results in increased energy consumption (e.g., gas mileage). Furthermore, the increase in drag force is often aggravated by the shape or type of the vehicle. For example, a sport utility vehicle typically creates more drag force when compared to a sports car.

Thus, while current vehicles achieve their intended purpose, there is a need to reduce drag force, especially when a vehicle operates at highway speeds.

### SUMMARY

According to several aspects, a vehicle having an active panel is disclosed. The vehicle defines a rearmost surface. The vehicle includes a frame defining a D-pillar, an active panel, and an actuation system. The active panel extends in a fore-and-aft direction of the vehicle and covers at least a portion of the D-pillar. The active panel defines a trailing edge that is oriented towards an aft direction and is moveable between a stowed position and a deployed position. The actuation system is operatively connected to the active panel and is configured to extend the active panel from the stowed position into the deployed position and from the deployed position into the stowed position. The trailing edge of the active panel is substantially aligned with the rearmost surface of the vehicle in the stowed position and extends beyond the rearmost surface of the vehicle in the deployed position.

In one aspect of the disclosure, the active panel further defines a leading edge facing a fore direction of the vehicle.

In another aspect of the disclosure, the vehicle further comprises a rear panel window. The leading edge of the active panel covers a portion of the rear panel window when in the stowed position.

In yet another aspect of the disclosure, the portion of the rear panel window covered by the leading edge of the active panel is uncovered when the active panel is in the deployed position.

In still another aspect of the disclosure, the vehicle further comprises a rear windshield. The active panel is located between the rear panel window and the rear windshield.

In another aspect of the disclosure, the active panel defines an outer surface. The outer surface includes a finish that corresponds to the rear panel window and the rear windshield.

In yet another aspect of the disclosure, a molding is located along the leading edge of the active panel and is configured to correspond with a trim located around a portion of an outer perimeter of the rear panel.

In still another aspect of the disclosure, the trailing edge of the active panel includes a projection shaped to guide air away from the rearmost surface of the vehicle.

In another aspect of the disclosure, the active panel further defines an upper edge oriented in a direction towards a roof of the vehicle and a lower edge oriented towards road wheels of the vehicle.

In yet another aspect of the disclosure, the upper edge and the lower edge of the active panel are oriented to diverge away from one another with respect to the aft direction of the vehicle.

In another aspect of the disclosure, the upper edge and the lower edge of the active panel are oriented to converge towards one another with respect to the aft direction of the vehicle.

In yet another aspect of the disclosure, the active panel is actuated into an outboard position by the actuation system.

In still another aspect of the disclosure, the active panel further defines an outer surface, and the outer surface of the active panel is colored to substantially match a body color of the vehicle.

In another aspect of the disclosure, the vehicle further comprises a control module in electronic communication with the actuation system.

In yet another aspect of the disclosure, the control module executes instructions for receiving a signal indicative of vehicle speed and comparing the vehicle speed with a threshold speed. In response to the vehicle speed being greater than the threshold speed, the control module instructs the actuation system to extend the active panel into the deployed position.

In still another aspect of the disclosure, the threshold speed represents a speed at which energy consumption of the vehicle relies more heavily upon a drag coefficient associated with the vehicle when compared to vehicle weight.

In another aspect of the disclosure, the control module further executes instructions for continuing to monitor the signal indicating vehicle speed after the active panel is in the deployed position and comparing the vehicle speed with the threshold speed. In response to determining the vehicle speed is less than the threshold speed, the control module instructs the actuation system to translate the active panel back into the stowed position.

In yet another aspect of the disclosure, a vehicle defining a rearmost surface is disclosed. The vehicle includes a frame defining a D-pillar, an active panel extending in a fore-and-aft direction of the vehicle, and an actuation system. The active panel covers at least a portion of the D-pillar and defines an inboard surface and an outboard surface. The actuation system is operatively connected to the active panel and is configured to rotate the active panel from the stowed position into the deployed position and from the deployed position into the stowed position. The inboard surface is concealed and the outboard surface is exposed when the active panel is in the stowed position and the inboard surface is exposed and a portion of the outboard surface is concealed when the active panel is in the deployed position. The inboard surface and at least one other surface of the vehicle cooperate to create a volume of space at the rearmost surface of the vehicle configured to create turbulent air flow.

In another embodiment of the disclosure, the vehicle further comprises a control module in electronic communication with the actuation system. The control module executes instructions for receiving signals indicating vehicle speed, a steering wheel indicator, and a brake pedal indicator.

In yet another aspect of the disclosure, the control module further executes instructions for comparing the vehicle speed to a threshold speed and determining that the driver's hands are on steering wheel and the brake pedal is depressed based on the signals for the steering wheel indicator and the brake pedal indicator. In response to determining that the vehicle speed is above the threshold speed, the driver's hands are on the steering wheel, and the brake pedal is depressed, the control module instructs the actuation system to rotate the active panel from the stowed position and into the deployed position.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a vehicle having an active panel that covers a D-pillar, according to an exemplary embodiment;

FIG. 2 is a side view of the vehicle in FIG. 1, where the active panel is in a stowed position according to an exemplary embodiment;

FIG. 3 is a side view of the vehicle where the active panel has been extended into a deployed position according to an exemplary embodiment;

FIG. 4 is a side view of the vehicle where the active panel has been removed to reveal the D-pillar, according to an exemplary embodiment;

FIG. 5 is a top view of the vehicle, where the active panel is in the stowed position according to an exemplary embodiment;

FIG. 6 is a top view of the vehicle, where the active panel is in the deployed position according to an exemplary embodiment;

FIG. 7 illustrates an alternative embodiment of the active panel according to an exemplary embodiment;

FIG. 8 illustrates the active panel shown in FIG. 7 being deployed in an outboard direction according to an exemplary embodiment;

FIG. 9 is an alternative embodiment of the active panel shown in FIG. 8, where the active panel is deployed in the outboard direction using another approach according to an exemplary embodiment;

FIG. 10 is a side view of the vehicle where the active panel has been removed and an actuation system is shown according to an exemplary embodiment;

FIG. 11 is a top view of another embodiment of the active panel in the stowed position, where the active panel acts as an air brake according to an exemplary embodiment; and

FIG. 12 is a top view of the active panel shown in FIG. 11 in the deployed position according to an exemplary embodiment.

### DETAILED DESCRIPTION

The following description is merely exemplary in nature and is not intended to limit the present disclosure, application, or uses.

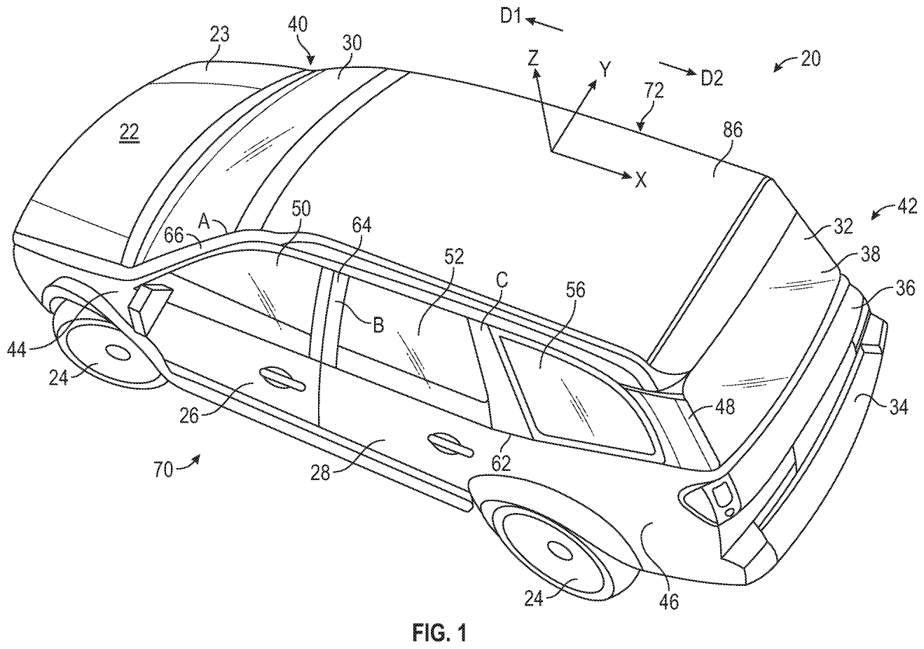

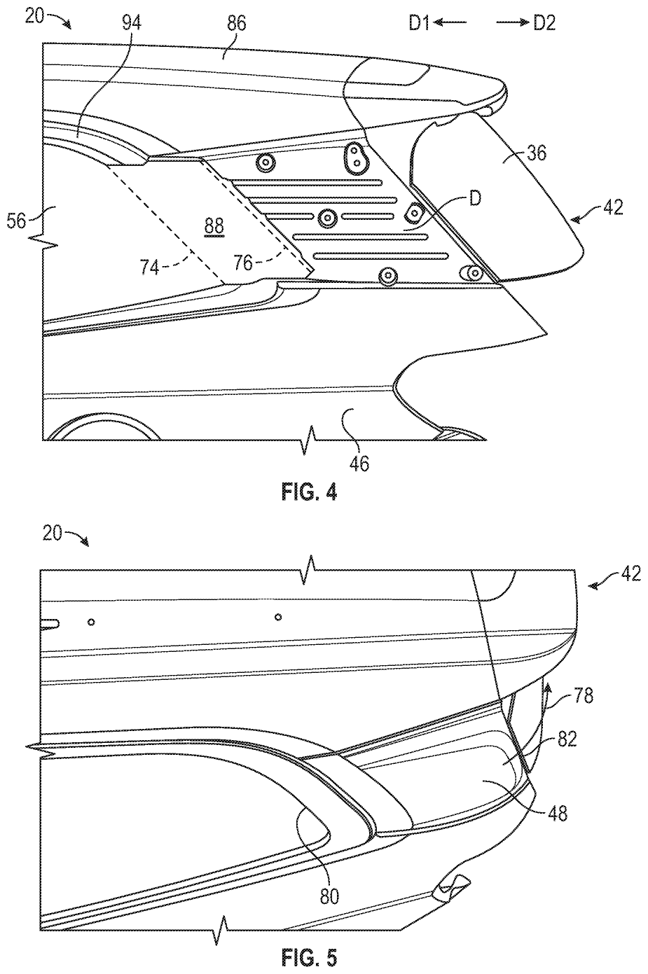

Referring to FIG. 1, an exemplary vehicle 20 is shown having a body 22. The vehicle 20 includes a pair of front road wheels 24, a pair of rear road wheels 24, a pair of front passenger doors 26, a pair of rear passenger doors 28, a front windshield 30, and a rear windshield 32. The body 22 of the vehicle 20 also includes a tailgate 36, a pair of front quarter panel 44, and a pair of rear quarter panels 46. The vehicle 20 also includes a pair of front passenger windows 50, a pair of rear passenger windows 52, and a pair of rear panel windows 56. In the embodiment as shown, the vehicle 20 is a sport utility vehicle and includes a pair of A-pillars (A), a pair of B-pillars (B) a pair of C-pillars (C), and a pair of active panels 48 that cover the D-pillars (D) (the D-pillars are not visible in FIG. 1 but one is shown in FIG. 4).

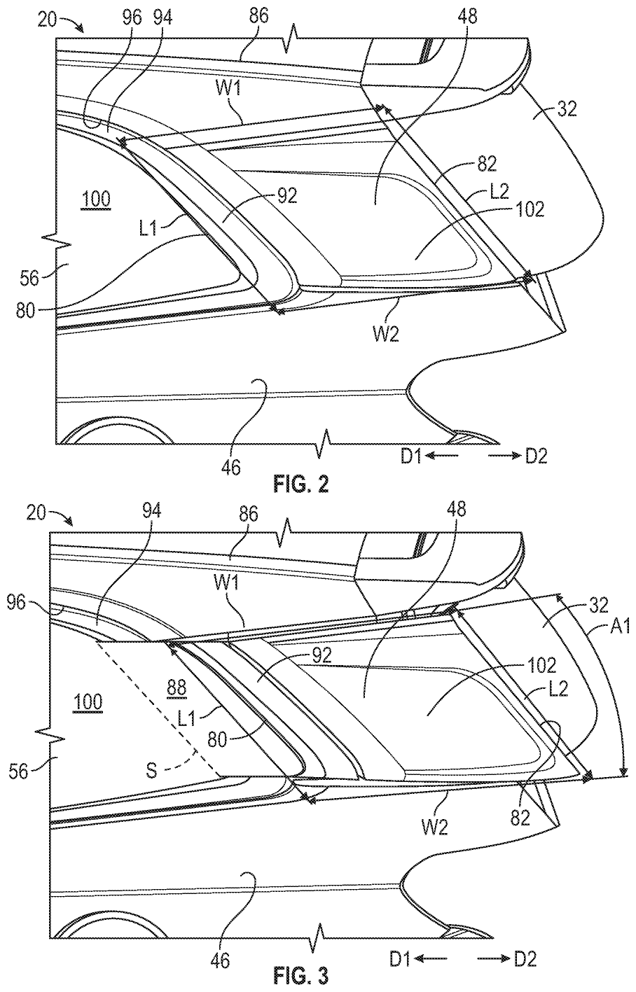

As explained below, the active panel 48 is configured to translate in a fore-and-aft direction D1-D2 of the vehicle 20. Specifically, the fore direction D1 is directed towards a front end 40 of the vehicle 20 and the aft direction D2 is directed towards the rear end 42 of the vehicle 20. A rearmost surface 38 of the vehicle 20 is located at the rear end 42 of the vehicle 20. The rearmost surface 38 is defined by the rear windshield 32, the tailgate 36, and a rear bumper 34 of the vehicle 20. The active panel 48 translates between a stowed position (shown in FIG. 2) and a deployed position (shown in FIG. 3).

It is to be appreciated that although FIG. 1 illustrates a sport utility vehicle, the vehicle 20 may be any type of vehicle 20 including D-pillars such as, for example a minivans or wagon. The D-pillars (D) are the rearmost roof support structures 60 that are located between the pair of rear panel windows 56 and the rear windshield 32. The C-pillars (C) are support structures 62 located between the rear passenger windows 52 and the rear panel windows 56. The B-pillars (B) are support structures 64 between the front passenger windows 50 and the rear passenger windows 52. The A-pillars (A) are the support structures 66 located on both sides of the front windshield 30.

In the embodiment as shown in FIG. 1, the vehicle 20 includes the rear windshield 32, the rear passenger windows 52, and the rear panel windows 56. However, in another embodiment the rear windshield 32, the rear passenger windows 52, and/or the rear panel windows 56 may be omitted. For example, some cargo vans may not include a rear windshield, rear passenger windows, or rear panel windows. It is to be appreciated that although only the exterior components located on a driver's side 70 of the vehicle 20 are visible in FIG. 1 (i.e., the front and rear road wheels 24, the front passenger doors 26, the rear passenger doors 28, etc.), a passenger's side 72 includes substantially the same exterior components as well.

The A-pillars (A), B-pillars (B), C-pillars (C), and the D-pillars (D) are all defined by a frame (not visible) of the vehicle 20. Specifically, the A-pillars (A), B-pillars (B), C-pillars (C), and the D-pillars (D) are all part of an upper portion of the frame. The frame of the vehicle 20 acts as a main support structure to which other components are attached to such as, for example, the front passenger doors 26, the rear passenger doors 28, and a hood 23. In one embodiment the frame may include a unibody structure. Alternatively, in another embodiment the frame may include a body-on-frame structure where the frame is attached to a separate chassis.

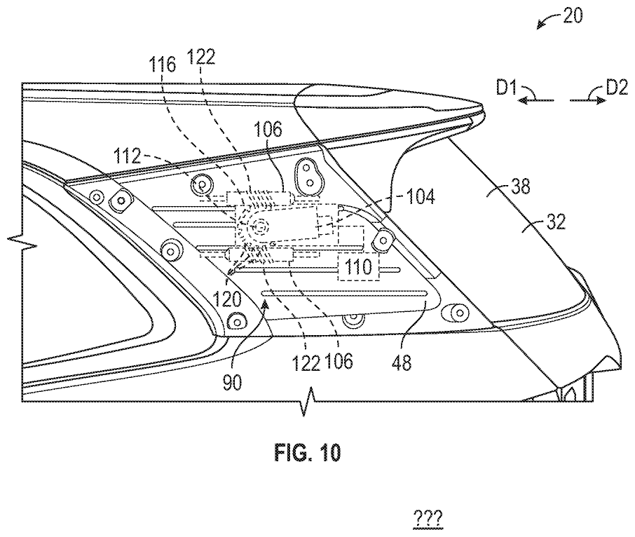

Referring now to FIGS. 1, 2, and 3, the active panel 48 is located between the rear panel window 56 and the rear windshield 32. The active panel 48 is oriented in the fore-and-aft direction D1-D2 of the vehicle 20 and covers at least a portion of the D-pillar (D). The active panel defines a leading edge 80 facing the fore direction D1 of the vehicle 20 and a trailing edge 82 facing the aft direction D2 the vehicle 20. The active panel 48 is moveable between the stowed position in FIG. 2 and the deployed position in FIG. 3 by an actuation system 90 shown in FIG. 10. The actuation system 90, which is described in greater detail below, is operatively connected to the active panel 48 and is configured to extend the active panel 48 from the stowed position into the deployed position and from the deployed position into the stowed position.

FIG. 4 illustrates the vehicle 20 with the active panel 48 and the actuation system 90 (FIG. 10) removed such that the D-pillar (D) is now visible. Two phantom lines are drawn along the rear panel window 56 and represent the position of the leading edge 80 of the active panel 48. Specifically, line 74 represents the position of the leading edge 80 of the active panel 48 when in the stowed position, and line 76 represents the position of the leading edge 80 of the active panel 48 when in the deployed position. The lines 74 and 76 define a portion 88 of the rear panel window 56. Referring now to FIGS. 2, 3, and 4, the leading edge 80 of the active panel 48 covers the portion 88 of the rear panel window 56 when in the stowed position of FIG. 2. However, when the active panel 48 extended into the deployed position of FIG. 3, the portion 88 of the rear panel window 56 covered by the leading edge 80 of the active panel 48 is uncovered. The rear panel window 56 appears to extend further in the aft direction D2 of the vehicle 20 when the active panel 48 is in the deployed position.

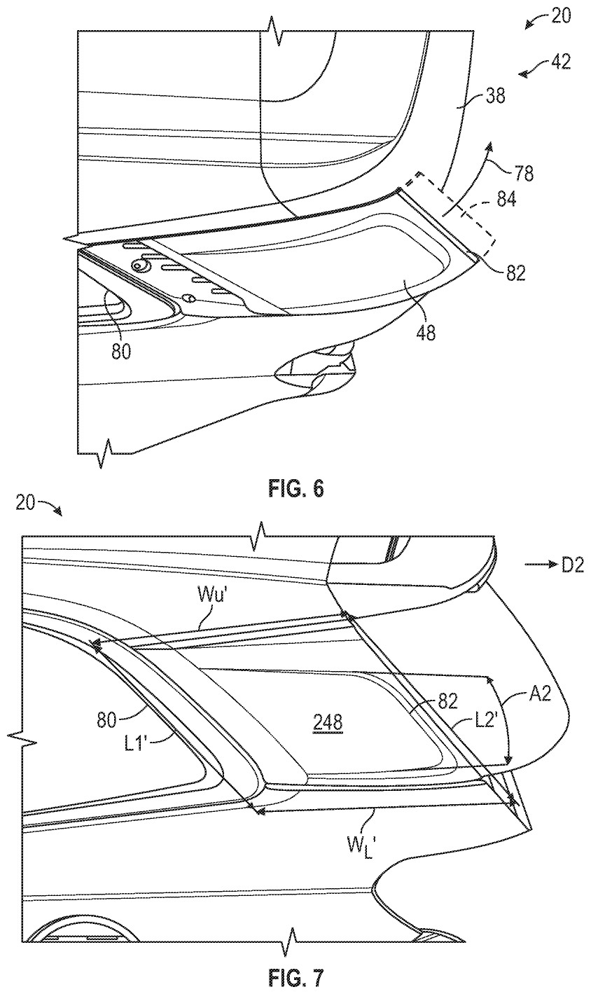

FIGS. 5 and 6 are a top view of the vehicle 20, where FIG. 5 illustrates the active panel 48 in the stowed position and FIG. 6 illustrates the active panel 48 in the deployed position. The trailing edge 82 of the active panel 48 is substantially aligned or flush with the rearmost surface 38 of the vehicle 20 when the active panel 48 is in the stowed position seen in FIG. 5. However, when in the deployed position of FIG. 6, the trailing edge 82 of the active panel 48 extends beyond the rearmost surface 38 of the vehicle 20. A flow of air 78 is directed away from the rearmost surface 38 of the vehicle 20 when the active panel 48 is in the deployed position, which in turn reduces aerodynamic drag. In contrast, when the active panel 48 is in the stowed position, the flow of air 78 is directed towards or wraps around the rearmost surface 38 of the vehicle 20, which in turn creates more aerodynamic drag when compared to the deployed position.

Referring to FIG. 6, in one embodiment the trailing edge 82 of the active panel 48 includes a projection 84, which is illustrated in phantom line. The projection 84 is shaped to guide the flow of air 78 away from the rearmost surface 38 of the vehicle 20. The projection 84 may be used to further reduce the aerodynamic drag of the vehicle 20. However, it is to be appreciated that the projection 84 is optional and may be omitted in some embodiments.

Turning back to FIGS. 2, 3, and 4, the active panel 48 may be constructed of materials such as, but not limited to, plastic and carbon fiber. The active panel 48 defines an outer surface 102 that is visible when installed on the vehicle 20. In one embodiment, the outer surface 102 is an applique surface that includes one or more decorative features such as, for example, contour lines. In the embodiment as shown, a molding 92 is located on the outer surface 102 and along the leading edge 80 of the active panel 48. A trim piece 94 extends around a portion of an outer perimeter 96 of the rear panel window 56. As seen in FIG. 2, the molding 92 of the active panel 48 is configured to correspond with the trim 94 around the rear panel window 56 to create a contiguous border around the rear panel window 56 when the active panel 48 is in the stowed position.

Although a molding 92 is described and shown in the figures, it is to be appreciated that this embodiment is merely exemplary in nature. In another embodiment, the outer surface 102 includes a finish that corresponds to the exterior of the rear panel window 56 and the rear windshield 32. In other words, the outer surface 102 of the active panel 48 includes a finish such as tinted glass that matches the glass of the rear panel window 56 and the rear windshield 32. This creates the appearance of a continuous glass pane that wraps around the D-pillar (D). In another embodiment, the outer surface 102 of the active panel 48 is of a color that substantially matches an exterior color of the vehicle 20. For example, if the body color of the vehicle 20 is a metallic gray, then the outer surface 102 of the active panel 48 is of a color that matches the metallic gray color.

It is to be appreciated that the active panel 48 is positioned in the stowed position of FIGS. 2 and 5 when the vehicle 20 is started and begins to operate. The active panel 48 is extended into the deployed position shown in FIGS. 3 and 6 when the vehicle 20 is operating at relatively higher vehicle speeds. This is because a drag coefficient C_{D} associated with the vehicle 20 increases with a square of vehicle speed. That is, if the vehicle speed doubles, then a value of the drag coefficient C_{D} quadruples. As a result, the energy consumption (e.g., the gas mileage) of a vehicle tends to rely more on the drag coefficient when the vehicle operates at highway speeds. For example, highway speeds may be vehicle speeds greater than about 65 kilometers/hour (about 40 miles/hour). In contrast, during city speed or stop-and-go traffic, energy consumption of a vehicle may rely more heavily on other characteristics of the vehicle such as weight.

Referring to FIGS. 2 and 3, in one embodiment the leading edge 80 of the active panel 48 includes a length L₁. The length L₁ is less than a length L₂ of the trailing edge 82 of the active panel 48. Therefore, it is to be appreciated that the active panel 48 is free to translate in a substantially linear direction between the stowed and deployed positions. The active panel 48 also defines an upper edge W_{U} and a lower edge W_{L}. The upper edge W_{U} of the active panel 48 is oriented towards a roof 86 of the vehicle 20, while the lower edge W_{L} is oriented towards the front and rear road wheels 24. In other words, the upper edge W_{U} of the active panel 48 faces an upward direction with respect to a vertical longitudinal axis z of the vehicle 20 (shown in FIG. 1) and the lower edge W_{L} faces a downward direction with respect to the vertical longitudinal axis z of the vehicle 20. FIG. 1 illustrates a three-dimensional Cartesian coordinate system of the vehicle 20 including an x-axis that is oriented in the fore-and-aft direction, a y-axis that is in the same plane and is perpendicular to the x-axis, and the vertical longitudinal axis z.

Referring to FIGS. 2 and 3, the upper edge W_{U} and the lower edge W_{L} of the active panel 48 are positioned to diverge from one another with respect to the aft direction D2 of the vehicle 20. In other words, the upper edge WU and the lower edge WL define an angle A1 (seen in FIG. 3). The upper edge W_{U} and the lower edge W_{L} represent the rays of the angle A₁. The rays of the angle A₁ (i.e., the upper edge W_{U} and the lower edge W_{L}) both project towards the aft direction D2 of the vehicle 20. This orientation of the upper edge W_{U} and the lower edge W_{L} provides the dimensions required to translate the active panel 48 in the aft direction D2 and into the deployed position as seen in FIG. 3 without any interference from the rear quarter panel 46 or the roof 86 of the vehicle 20.

In another embodiment as described below and shown in FIG. 7, the upper edge W_{U} and the lower edge W_{L} are not oriented to diverge from one another. Furthermore, although the figures illustrate the active panel 48 having a unitary upper edge W_{U} and a unitary lower edge W_{L} (i.e., the edges are both defined a single straight line), it is to be appreciated that this embodiment is exemplary in nature. In another embodiment the upper and lower edges of the active panel 48 may include a curved profile or a profile that is comprised of multiple lines that extend in different directions.

Turning now to FIG. 7, an alternative embodiment of the active panel 248 is shown where the upper edge W_{U}′ and the lower edge W_{L}′ are not oriented to diverge from one another. A length L₁′ of the leading edge 80 of the active panel 248 is less than a length L₂′ of the trailing edge 82 of the active panel 248. Furthermore, in the embodiment as shown in FIG. 7 an upper edge W_{U}′ and a lower edge W_{L}′ of the active panel 248 are positioned to converge towards one another with respect to the aft direction D2 of the vehicle 20. The upper edge W_{U}′ and the lower edge W_{L}′ of the active panel 48 define an angle A₂, where the upper edge W_{U}′ and the lower edge W_{L}′ represent the rays of the angle A₂. As seen in FIG. 7, the rays of the angle A₂ (i.e., the upper edge W_{U}′ and the lower edge W_{L}′) both project towards the aft direction D2 of the vehicle 20.

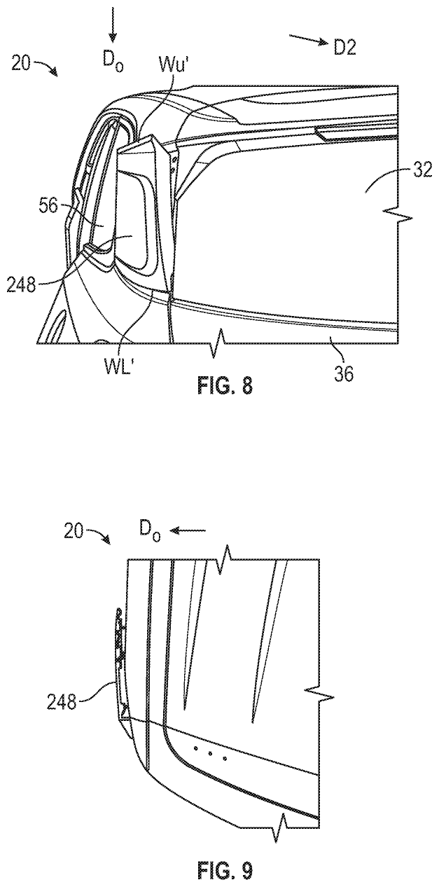

In contrast to the embodiment as shown in FIGS. 2 and 3, the orientation of the upper edge W_{U}′ and the lower edge W_{L}′ shown in FIG. 7 create an interference when the active panel 48 translates in the aft direction D₂. Therefore, before the active panel 248 may be extended into the deployed position the active panel 48 is first actuated in an outboard direction D_{O} relative to the vehicle 20, which is shown in FIG. 8. Referring to both FIGS. 1 and 8, the outboard direction D_{O} is oriented in the same direction as the y-axis of the three-dimensional Cartesian coordinate system of the vehicle 20.

Continuing to refer to both FIGS. 1 and 8, in one embodiment the active panel 248 is actuated to rotate about the lower edge W_{L}′ of the active panel 48, which in turn urges the upper edge WU′ of the active panel 248 in the outboard direction D_{O} of the vehicle 20. Once the active panel 248 is actuated into the outboard position D_{O}, the active panel 248 is free to translate in the aft direction D₂ without interference. Although FIG. 8 illustrates the lower edge W_{L}′ being actuated to rotate, it is to be appreciated that in another embodiment the upper edge W_{U}′ may be rotated instead. FIG. 9 illustrates an alternative approach for actuating the active panel 248 in the outboard direction D_{O}. In the embodiment as shown in FIG. 9, the entire active panel 248 is moved in the outboard direction D_{O}, unlike the embodiment shown in FIG. 8 that only rotates one of the edges W_{U}′, W_{L}′ of the active panel 248. The outboard movement of the active panel 248 is also created by the actuation system 90 (FIG. 10).

FIG. 10 is a side view of the vehicle 20 illustrating the actuation system 90, which is drawn in phantom line because the actuation system 90 is located behind the active panel 48 and is not visible. In the exemplary embodiment as shown in FIG. 10, the actuation system 90 includes a actuator 104 and a pair of worm gears 106. The actuator 104 is in electronic communication with a control module 110. The control module 110 generates electronic signals that control the actuation of the actuator 104. The electronic signals generated by the control module 110 are sent to the actuator 104. The control module 110 is an electronic control device having a preprogrammed digital computer or processor, control logic or circuits, memory used to store data, and at least one I/O peripheral. The control logic includes or enables a plurality of logic routines for monitoring, manipulating, and generating data and control signals.

The control module 110 receives as input the vehicle speed, which may be sent directly from a speed sensor or from another control module. In addition to vehicle speed, in some embodiments other factors such as ambient temperature and time may also be sent to the control module 110 as input. The control module 110 generates electronic signal that instruct the actuator 104 to activate and deactivate. In the embodiment as shown the actuator 104 is a rotary actuator, therefore the control module 110 also instructs a direction of rotation by the actuator 104. More specifically, the control module 110 instructs the actuator 104 to drive an output 112 to rotate in either a clockwise direction or a counterclockwise direction. The output 112 may be, for example, a round or hex shaped aperture for receiving a shaft. The rotation of the output 112 drives a spur gear 116. A plurality of teeth 120 around the spur gear 116 and are configured to mate with a worm screw 122 of both worm gears 106.

The control module 110 generates electronic signals that are sent to the actuator 104. The electronic signals instruct the actuator 104 to drive the output 112 in the clockwise direction, which in turn causes the worm gears 106 to translate in the aft direction D₂ of the vehicle 20. The worm gears 106 are connected to the active panel 48 (FIG. 1-3). Therefore, the active panel 48 is extended into the deployed position. Similarly, instructing the actuator 104 to drive the output 112 in the counterclockwise direction results in the active panel 48 translating in the fore direction D₁. It is to be appreciated that the actuation system 90 illustrated in FIG. 10 is exemplary in nature. Other actuation systems such as, for example, linear actuators, cable and pulley systems, or wind force and retention springs may also be used as well.

Referring now to FIGS. 2, 3, and 8, the active panel 48 is in the stowed position when the vehicle 20 is started (i.e., turn the ignition switch to the on position). The control module 110 receives as input a signal indicating the vehicle speed. As explained below, other factors such as ambient temperature may be received as input by the control module 110 as well. The control module 110 monitors the vehicle speed as the vehicle 20 operates. The control module 110 compares the vehicle speed with the threshold speed, and in response to the vehicle speed being greater than the threshold speed, the control module 110 generates electronic signals that are received by the actuator 104. The electronic signals instruct the actuator 104 to rotate the output 112 in a clockwise direction, which in turn cause the active panel 48 to translate in the aft direction D₂ and into the deployed position. The threshold speed represents a vehicle speed at which energy consumption of the vehicle 20 relies more heavily upon the drag coefficient C_{D} associated with the vehicle 20 when compared to vehicle weight. For example, the threshold speed may be highway driving speeds (i.e., 65 kilometers/hour or more).

The control module 110 continues to monitor the vehicle speed as the vehicle 20 operates. In response to determining the vehicle speed is less than the threshold speed, the control module 110 generates electronic signals instructing the actuator 104 to rotate the output 112 in the counterclockwise direction, which in turn causes the worm gears 106 to translate in the fore direction D₁ of the vehicle 20. Since the worm gears 106 are operationally connected to the active panel 48, it is to be appreciated that the active panel 48 is translated into the stowed position. In other words, in response to determining the vehicle speed is less than the threshold speed, the control module 110 instructs the actuation system to translate the active panel 48 back into the stowed position.

In addition to vehicle speed, the active panel 48 may be extended into the deployed position and translated back into the stowed position based on other factors such as, but not limited to, ambient temperature and time. For example, in one embodiment the control module 110 monitors the vehicle speed for a predetermined time in response to determining the vehicle speed is greater than the threshold speed. In response to determining that the vehicle speed is greater than the threshold speed for the predetermined time, then the control module 110 generates electronic signals that are sent to the actuator 104 for deploying the active panel 48 The predetermined time is of a sufficient length to ensure that the vehicle 20 is consistently operating at highway speeds and has not momentarily accelerated. For example, the vehicle 20 may momentarily accelerate based on traffic conditions (e.g., to overtake another vehicle).

In some embodiments the control module 110 receives as input ambient temperature from a sensor or from another control module. The control module 110 compares the ambient temperature to a threshold temperature. In response to determining the ambient temperature is less than the threshold temperature, the control module 110 does not generate electronic signals to deploy the active panel 48 (i.e., the output 112 of the actuator 104 is not rotated). The threshold temperature is low enough for snow and ice to be present. For example, in one embodiment is about 4° C.

Referring now to FIGS. 1-10, various technical benefits and effects of the disclosed active panel include improved energy consumption at higher vehicle speeds. More specifically, the active panel is extended into the deployed position when the vehicle operates at highway speeds to direct airflow away from the rear portion of the vehicle. Directing airflow in a direction away from the rear of the vehicle improves the aerodynamic drag associated with the vehicle, which in turn improves energy consumption. Furthermore, the disclosed active panel provides a flush, uninterrupted appearance that seamlessly blends with the vehicle exterior. Some other systems may expose the actuation elements when deploying one or more aerodynamic features. In contrast, the disclosed active panel conceals the actuation system when in the stowed as well as the deployed positions.

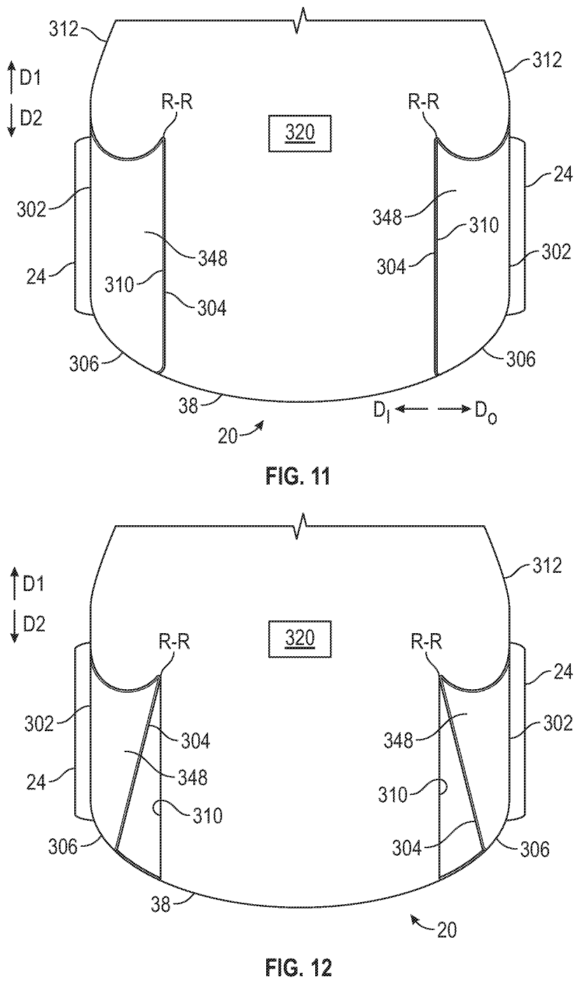

FIGS. 11 and 12 illustrate an alternative embodiment of active panels 348 that are deployed from the stowed position and into the deployed position to act as an air brake. FIG. 11 illustrates the active panels 348 in the stowed position and FIG. 12 is an illustration of the active panels 348 in the deployed position. The active panels 348 also extend in the fore-to-aft direction D1-D2 of the vehicle 20 and cover at least a portion of the D-pillars (D) of the vehicle 20 (one of the D-pillars are visible in FIG. 4). However, it is to be appreciated that in another embodiment the active panels 348 may be used to cover the C-pillars (C) of the vehicle 20 instead (the C-pillars are shown in FIG. 1).

Each active panel 348 defines an outboard surface 302 that is exposed when the active panel 348 is in the stowed position shown in FIG. 11. The outboard surface 302 of the active panel 348 is contiguous with exterior surfaces 312 of the vehicle 20. The active panel 348 also defines an inboard surface 304 and a trailing end surface 306. The inboard surface 304 of the active panel 348 is hidden or concealed when the active panel 348 is in the stowed position. As explained below, when the active panel 348 is rotated into the deployed position in FIG. 12, a portion of the outboard surface 302 is concealed and the inboard surface 304 is now visible. Referring to FIG. 11, the outboard surface 302 of the active panel is positioned to face in the outboard direction D_{O} of the vehicle 20 when the active panel 348 is in the stowed position. Also, the inboard surface 304 of the active panel 348 is positioned to face towards an inboard direction D_{I} of the vehicle 20 when the active panel is in the stowed position.

Continuing to refer to FIG. 11, the trailing end surface 306 of the active panel 348 is aligned with or flush with the rearmost surface 38 of the vehicle 20 when the active panel 348 is in the stowed position. The active panel 348 is rotated about an axis of rotation R-R and into the deployed position shown in FIG. 12 by an actuation system (not visible in the figures). Specifically, the active panel 348 is rotated about the axis of rotation R-R in the outboard direction D_{O} (i.e., in the clockwise direction). Also, the inboard surface 304 of the active panel 348 is exposed. Furthermore, a longitudinal surface 310 defined by an exterior portion of the vehicle 20 is exposed when the active panel 348 is in the deployed position.

Referring to FIGS. 11 and 12, the longitudinal surface 310 of the vehicle 20 is positioned to directly oppose the inboard surface 304 of the active panel 348 when the active panel 348 is in the stowed position. In the embodiment as shown in the figures, the longitudinal surface 310 is oriented substantially parallel with respect to the x-axis of the three-dimensional Cartesian coordinate system of the vehicle 20 that extends in the fore-and-aft direction (shown in FIG. 1). However, it is to be appreciated that the embodiment shown in FIGS. 11 and 12 are merely exemplary in nature and the longitudinal surface 310 may be oriented in a direction that is not substantially parallel to the x-axis as well.

The actuation system may be any mechanism for rotating the active panel such as, for example, an inflatable bladder, rotational actuator, or a linear actuator. The inflatable bladder is filled with air to push the active panel 348 and thereby cause rotation. In the event a rotational actuator is employed, the rotational actuator is positioned along the axis of rotation R-R of the active panel 348. In the event a linear actuator is used, the linear actuator is positioned along the longitudinal surface 310 and exerts a force in the outboard direction D_{O} to urge the active panel 348 into the deployed position. Regardless of what type of actuation system is used, a control module 320 is provided and is in electronic communication with the actuation system.

The control module 320 receives as input the vehicle speed, an indication that a driver's hands are on the steering wheel of the vehicle 20, and an indication that a brake pedal of the vehicle 20 is depressed. The signals for the vehicle speed, the indication that the driver's hands are on the steering wheel, and the indication that the brake pedal is depressed may be received by sensors or from other control modules of the vehicle 20. The control module 320 monitors the vehicle speed, the steering wheel indicator, and the brake pedal indicator. In response to determining that the vehicle speed is above the threshold speed (i.e., highway speeds), the presence of driver's hands on the steering wheel, and the brake pedal is depressed, the control module 320 generates signals instructing the actuation system to rotate the active panel 348 about the axis of rotation R-R from the stowed position and into the deployed position.

When in the deployed position as seen in FIG. 12, the active panel 348 acts as an air brake to increase the drag coefficient C_{D} associated with the vehicle 20. More specifically, the inboard surface 304 of the active panel 348 and the longitudinal surface 310 defined by the exterior of the vehicle 20 cooperate with one another to create a volume of space along the rearmost surface 38 of the vehicle 20. The volume of space is referred to as a turbulent flow area T. This is because air flows around the vehicle 20 and is directed towards the volume of space defined by the inboard surface 304 and the longitudinal surface 310. Once air is in the volume of space defines by the surfaces 304, 310, the air becomes turbulent in flow (as opposed to a laminar flow). Increasing or providing turbulence also increases the drag coefficient C_{D} associated with the vehicle 20. Creating more drag increases the rate of deceleration, which is beneficial when a driver is applying the brakes. Therefore, the active panel 348 provides air braking capabilities during a deceleration event.

Referring to FIGS. 11 and 12, the disclosed active panel provides air braking capabilities in a vehicle during highway speed braking conditions. Technical effects and benefits of the disclosed active panel include gains in brake cooling, reduced braking distances, and reduced load upon the brakes when operated at highway speeds.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A vehicle defining a rearmost surface, comprising:
a frame defining a D-pillar;
an active panel extending in a fore-and-aft direction of the vehicle and covering at least a portion of the D-pillar, the active panel defining a trailing edge that is oriented towards an aft direction and is moveable between a stowed position and a deployed position; and
an actuation system operatively connected to the active panel and configured to extend the active panel from the stowed position into the deployed position and from the deployed position into the stowed position, wherein the trailing edge of the active panel is substantially aligned with the rearmost surface of the vehicle in the stowed position and extends beyond the rearmost surface of the vehicle in the deployed position.

2. The vehicle of claim 1, wherein the active panel further defines a leading edge facing a fore direction of the vehicle.

3. The vehicle of claim 2, further comprising a rear panel window, wherein the leading edge of the active panel covers a portion of the rear panel window when in the stowed position.

4. The vehicle of claim 3, wherein the portion of the rear panel window covered by the leading edge of the active panel is uncovered when the active panel is in the deployed position.

5. The vehicle of claim 3, further comprising a rear windshield, wherein the active panel is located between the rear panel window and the rear windshield.

6. The vehicle of claim 5, wherein the active panel defines an outer surface, and wherein the outer surface includes a finish that corresponds to the rear panel window and the rear windshield.

7. The vehicle of claim 3, wherein a molding is located along the leading edge of the active panel and is configured to correspond with a trim located around a portion of an outer perimeter of the rear panel window.

8. The vehicle of claim 1, wherein the trailing edge of the active panel includes a projection shaped to guide air away from the rearmost surface of the vehicle.

9. The vehicle of claim 1, wherein the active panel further defines an upper edge oriented in a direction towards a roof of the vehicle and a lower edge oriented towards road wheels of the vehicle.

10. The vehicle of claim 9, wherein the upper edge and the lower edge of the active panel are oriented to diverge away from one another with respect to the aft direction of the vehicle.

11. The vehicle of claim 9, wherein the upper edge and the lower edge of the active panel are oriented to converge towards one another with respect to the aft direction of the vehicle.

12. The vehicle of claim 11, wherein the active panel is actuated into an outboard position by the actuation system.

13. The vehicle of claim 1, wherein the active panel further defines an outer surface, and wherein the outer surface of the active panel is colored to substantially match a body color of the vehicle.

14. The vehicle of claim 1, further comprising a control module in electronic communication with the actuation system.

15. The vehicle of claim 14, wherein the control module executes instructions for:
receiving a signal indicative of vehicle speed;
comparing the vehicle speed with a threshold speed;
in response to the vehicle speed being greater than the threshold speed, instructing the actuation system to extend the active panel into the deployed position.

16. The vehicle of claim 15, wherein the threshold speed represents a speed at which energy consumption of the vehicle relies more heavily upon a drag coefficient associated with the vehicle when compared to vehicle weight.

17. The vehicle of claim 15, wherein the control module further executes instructions for:
continuing to monitor the signal indicating vehicle speed after the active panel is in the deployed position;
comparing the vehicle speed with the threshold speed; and
in response to determining the vehicle speed is less than the threshold speed, instructing the actuation system to translate the active panel back into the stowed position.

18. A vehicle defining a rearmost surface, comprising:
a frame defining a D-pillar;
an active panel extending in a fore-and-aft direction of the vehicle and covering at least a portion of the D-pillar, the active panel defining an inboard surface and an outboard surface; and
an actuation system operatively connected to the active panel and configured to rotate the active panel from the stowed position into the deployed position and from the deployed position into the stowed position, wherein the inboard surface is concealed and the outboard surface is exposed when the active panel is in the stowed position and the inboard surface is exposed and a portion of the outboard surface is concealed when the active panel is in the deployed position, and wherein the inboard surface and at least one other surface of the vehicle cooperate to create a volume of space at the rearmost surface of the vehicle configured to create turbulent air flow.

19. The vehicle of claim 18, further comprising a control module in electronic communication with the actuation system, wherein the control module executes instructions for:
receiving signals indicating vehicle speed, a steering wheel indicator, and a brake pedal indicator.

20. The vehicle of claim 19, wherein the control module further executes instructions for:
comparing the vehicle speed to a threshold speed;
determining that the driver's hands are on steering wheel and the brake pedal is depressed based on the signals for the steering wheel indicator and the brake pedal indicator; and
in response to determining that the vehicle speed is above the threshold speed, the driver's hands are on the steering wheel, and the brake pedal is depressed, instructing the actuation system to rotate the active panel from the stowed position and into the deployed position.
